(19) United States
(12) Patent Application Publication
(10) Pub. No.: US 2013/0347011 A1
(43) Pub. Date: Dec. 26, 2013

(54) INSTALLER AND METHOD FOR ADDING AN ANDROID PLATFORM DYNAMIC LIBRARY

(71) Applicants: Hoon Choi, Daejeon-si (KR); Byung-Sung Park, Suwon-si (KR); Yong-Duck You, Daejeon-si (KR)

(72) Inventors: Hoon Choi, Daejeon-si (KR); Byung-Sung Park, Suwon-si (KR); Yong-Duck You, Daejeon-si (KR)

(73) Assignee: INDUSTRY FOUNDATION OF CHONNAM NATIONAL UNIVERSITY, Gwanju-si (KR)

(21) Appl. No.: 13/996,950

(22) PCT Filed: Nov. 18, 2011
(86) PCT No.: PCT/KR11/08833

§ 371 Date: Sep. 10, 2013

(30) Foreign Application Priority Data
Dec. 24, 2010 (KR) 10-2010-0134365

(51) Int. Cl. G06F 9/445

(52) U.S. Cl. CPC G06F 9/44521
USPC 719/331

(57) ABSTRACT

An installer for adding an Android platform dynamic library comprises a unit for generating an external directory which generates an external directory for storing a library, a unit for generating library information which generates library information including at least one of library name information and library location information, and a control unit which stores the library in the external directory and stores the generated library information in an external library management directory.

### TECHNICAL FIELD

The following description relates to a technology for adding an Android platform dynamic library.

### BACKGROUND ART

These days, various kinds of smart phones are being developed and widely dispersed. For example, Apple's iOS and Google's Android are widely used in smart phones as platforms. In particular, Android, an open source mobile phone platform, is drawing a lot of attention and becoming more popular.

In general, a mobile application is developed using Application Programming Interface (API) provided in a mobile platform. Yet, not only API, but also an external library is used in developing an application because a mobile platform cannot provide every function.

On the Android platform, an external library is included in an application as part of an application code. However, if a plurality of applications using the same external library exist in a single terminal, all of the applications must include the same external library code. Thus, each application may have a bigger file size compared to when all of the applications share one library code, and thus unnecessary storage space is used.

In addition, because smartphones have limited storage space, a method is needed to help multiple applications use a shared library added to a mobile platform without the desired library in each application.

However, in order to add a new library on the current Android mobile platform, a platform of a mobile terminal can only be changed after generating a new platform binary image that includes the pending library.

The above offline service method is very inconvenient and inefficient, and thus, a method for adding a dynamic library to a platform operating on a mobile terminal needs to be developed.

### TECHNICAL PROBLEM

The following description aims to provide an installer and method for adding an Android platform dynamic library without changing the Android platform.

### TECHNICAL SOLUTION

In one general aspect, an installer for adding an Android platform dynamic library is provided, and the installer includes an external directory generator configured to generate an external directory to store a library; a library information generator configured to generate library information including at least one of name information and location information of the library; and a controller configured to store the library in the external directory, and store the library information in an external library management directory.

The installer may further include a determiner configured to determine whether the library has already been installed, wherein the external directory generator generates the external directory according to a result of a determination.

The installer may further include a library receiver configured to receive the library from an external device.

The external directory generator may generate the external directory on an application framework layer or a library layer of an Android platform.

In still another general aspect, a method for adding an Android platform dynamic library is provided, and the method includes generating an external directory to store a library; generating library information including at least one of name information and location information of the library; storing the library in the external directory; and storing the library information in an external library management directory.

The method may further include determining whether the library has already been installed, wherein the generating of the external directory comprises generating the external directory according to a result of a determination.

The method may further include, in response to a signal requesting library download, receiving the library from an external server.

The generating of the external directory may include generating the external directory on an application framework layer or a library layer of an Android platform.

### ADVANTAGEOUS EFFECTS

According to exemplary embodiments of the present invention, it is possible to add an Android platform dynamic library without changing the Android platform.

### DESCRIPTION OF DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating an installer for adding an Android platform dynamic library according to an exemplary embodiment of the present invention;

FIG. 2 is a diagram illustrating an Android platform including the installer shown in FIG. 1; and

FIG. 3 is a diagram illustrating a method for adding an Android platform dynamic library according to an exemplary embodiment of the present invention.

### BEST MODE

The invention is described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

The accompanying drawings, which are included to provide a further understanding of the invention and are incorporated in and constitute a part of this specification, illustrate embodiments of the invention, and together with the description serve to explain the principles of the invention.

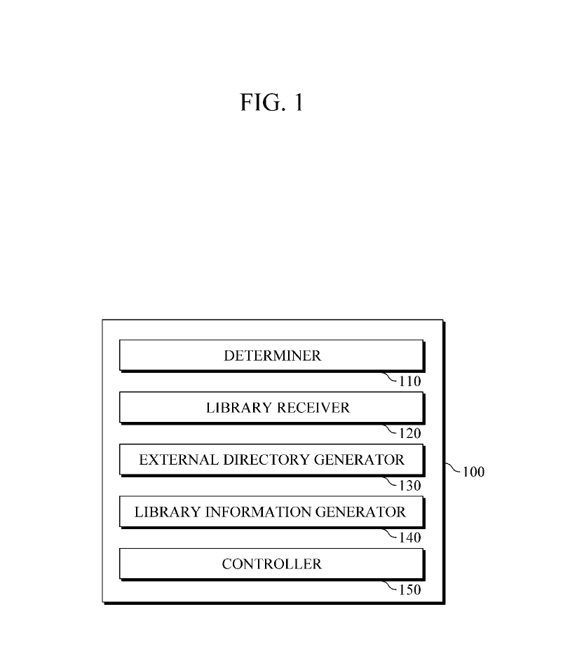

FIG. 1 is a diagram illustrating an installer for adding an Android platform dynamic library according to an exemplary embodiment of the present invention.

Referring to FIG. 1, an installer 100 for adding an Android platform dynamic library includes a determiner 110, a library receiver 120, an external directory generator 130, a library information generator 140 and a controller 150.

If a signal for adding a library is received, the determiner 110 may determine whether a library desired to be added has already been installed to the Android platform. If it is determined that the desired library has already been installed to the Android platform, the installer 100 does not add the library. On the other hand, if it is determined that the desired library has not been installed to the Android platform, the library receiver 120 receives the desired library from an external device. For example, the external device may be an external server, an external memory or an external portable terminal.

The external directory generator 130 generates an external directory to store a received library. For example, the external directory generator 130 may generate an external directory on an application framework layer or a library layer of the Android platform.

The library information generator 140 generates library information including at least one of name information and location information of a library. Based on the location information of a library, an application may find a location of the library easily.

The controller 150 stores the desired library in a generated external directory. The controller 150 stores the library information in the external library management directory. The controller 150 may store the library information in the external library management directory of the Android platform as well as a default library management directory. Using user identifications (IDs), the controller 150 may restrict an installer, which adds a dynamic library to the Android platform, to access only the external directory and the external library management directory. Accordingly, a user cannot access a default library on the manufacturer-provided Android platform, to add a library, and thus, it is possible to maintain security of the system provided by the manufacturer. For example, by setting a user ID of an external directory and an external library management directory as ‘system’ and setting a user ID of an installer for adding a dynamic library to the Android platform as ‘system’, the controller 150 may restrict the installer to access only to the external directory and the external library management directory.

Accordingly, the user is capable of adding a dynamic library to the external directory using the installer while maintaining security of the system provided by the manufacturer.

In addition, it is possible to add a dynamic library without changing the Android platform.

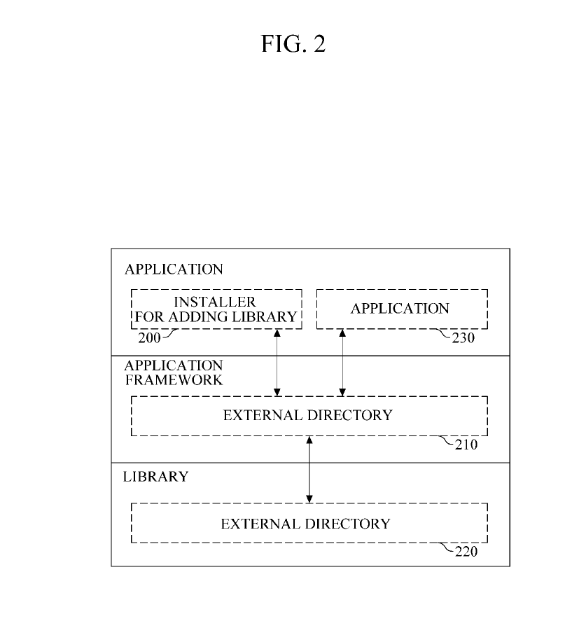

FIG. 2 is a diagram illustrating an Android platform including an installer shown in FIG. 1.

Referring to FIG. 2, an installer 200 for adding a dynamic library may be included on an application layer of the Android platform. If a signal for adding a library is received, the installer 200 may generate an external directory 210 on an application framework layer of the Android platform or an external directory 220 on a library layer of the Android platform. An application included on the application layer may access the external directories 210 and 220.

Accordingly, it is possible not only to add a dynamic library to the Android platform, but also to freely access a library in which an application is added.

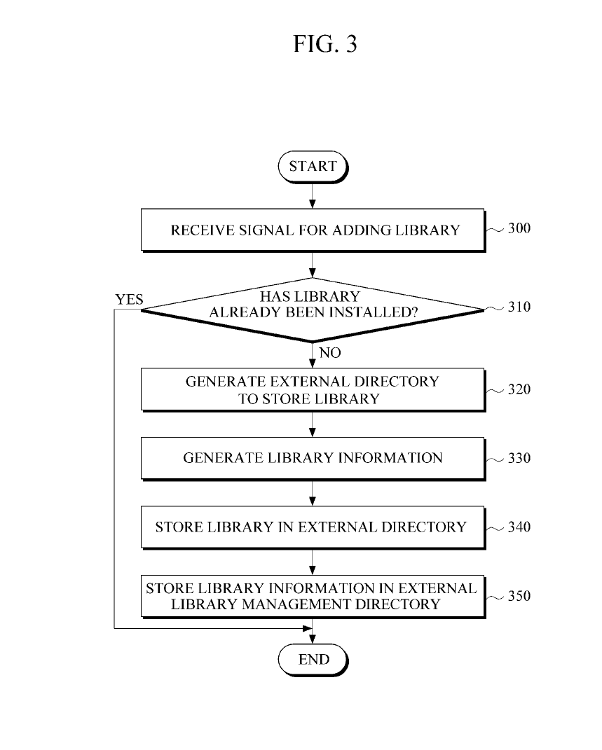

FIG. 3 is a diagram illustrating an example of a method for adding a dynamic library to the Android platform according to an exemplary embodiment of the present invention.

Referring to FIG. 3, an installer for adding a dynamic library to the Android platform receives a signal for adding a library in 300. The installer determines whether a library desired to be added has already been installed in 310. If it is determined that the desired library has already been installed, the installer does not add the library.

On the other hand, if it is determined that the desired library has not been installed, the installer generates an external directory to store a received library in 320. For example, the external directory generator 130 may generate an external directory on an application framework layer or a library layer of the Android platform. The installer may receive a library desired to be added from an external device. For example, the external device may include an external server, an external memory and an external portable terminal.

The installer generates library information including at least one of name information and location information of a library in 330. The installer stores a library desired to be added in the generated external directory in 340. The installer stores the library information in the external library management directory in 350. The method for adding a dynamic library to the Android platform may further include assigning a user ID to the installer, the external directory, and the external library management directory in order to restrict the installer to access only the external directory and the external library management directory.

Accordingly, a user is capable of not only adding a dynamic library to the external directory but also of maintaining security of a system provided by a manufacturer.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. Some of the described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

1. An installer for adding an Android platform dynamic library, the installer comprising:
an external directory generator configured to generate an external directory to store a library;
a library information generator configured to generate library information including at least one of name information and location information of the library; and
a controller configured to store the library in the external directory and store the library information in an external library management directory.

2. The installer of claim 2, further comprising:
a determiner configured to determine whether the library has already been installed,
wherein the external directory generator generates the external directory according to a result of a determination.

3. The installer of claim 1, further comprising:
a library receiver configured to receive the library from an external device.

4. The installer of claim 1, wherein the unit configured to generate an external directory generates the external directory on an application framework layer or a library layer of an Android platform.

5. The installer of claim 1, wherein the controller assigns a user identification (ID) to the installer, the external directory, and the external library management directory in order to restrict the installer to access only the external directory and the external library management directory.

6. A method for adding an Android platform dynamic library, the method comprising:
generating an external directory to store a library;
generating library information including at least one of name information and location information of the library;
storing the library in the external directory; and
storing the library information in an external library management directory.

7. The method of claim 6, further comprising:
determining whether the library has already been installed,
wherein the generating of the external directory comprises generating the external directory according to a result of a determination.

8. The method of claim 6, further comprising:
in response to a signal requesting library download, receiving the library from an external server.

9. The method of claim 6, wherein the generating of the external directory comprises generating the external directory on an application framework layer or a library layer of an Android platform.

10. The method of claim 6, further comprising:
assigning a user identification (ID) to an installer for adding an Android platform dynamic library, the external directory, and the external library management directory in order to restrict the installer to access only the external directory and the external library management directory.
